(19) United States
(12) Patent Application Publication
(10) Pub. No.: US 2010/0219969 A1
(43) Pub. Date: Sep. 2, 2010

(54) ASSEMBLY OF A REMOTE CONTROL AND A REMOTE CONTROLLABLE APPARATUS

(76) Inventor: Bent Christensen, Vinderup (DK)

Correspondence Address: HARNESS, DICKEY & PIERCE, P.L.C., P.O. BOX 8910, RESTON, VA, 20195, US

(21) Appl. No.: 12/734,133

(22) PCT Filed: Sep. 30, 2008
(86) PCT No.: PCT/EP2008/063080

§ 371 Date: Apr. 13, 2010

(30) Foreign Application Priority Data
Oct. 16, 2007 (US) 60960834

(51) Int. Cl. G08B 21/00

(52) U.S. Cl. 340/686.6

(57) ABSTRACT

An assembly of an apparatus and a remote control, where the apparatus has a surface part a surface part adapted to support the remote control and a movable element movable between a position at which the remote control may be supported and a position at least partly covering the surface part. Thus, the surface part is only visible or accessible when the remote control is supported or in the proximity of the apparatus.

The present invention relates to an assembly of a remote control and a remote controllable apparatus and in particular to an apparatus having a surface adapted to support the remote control and an element adapted to block or hide the surface, when the remote control is not in the proximity of the apparatus. In one embodiment, the remote control may be electrically connected to the apparatus when supported or docked, so as to e.g. charge a battery of the remote control.

In general, remote controllable apparatus are known. From a wide variety of apparatus, such as stereos, TV's, DVD players/recorders, VHS players/recorders, CD players, tape recorders, computers, or the like.

In a first aspect, the invention relates to an assembly of an apparatus and a remote control,

the remote control comprising means for receiving instructions from a user and means for outputting a signal correlated to instructions received,

the apparatus comprising means for receiving a signal from the remote control and acting accordingly,

the apparatus further comprising
a surface part adapted to support the remote control,
a movable element movable between a first and a second position,

where the surface part is at least partly covered by the movable element, when the movable element is in the first position, and is not covered to any substantial degree, when the movable element is in the second position.

In the present context, the receiving means may be any type of manipulatable element, such as push buttons, potentiometers, touch pads/screens, rotatable or otherwise movable/displaceable elements, or the like. Also, the signal output of the remote control preferably is a wireless signal, such as a signal based on electromagnetic radiation (typically IR radiation) or RF waves. Naturally, the signal may be transported via wires (electrically conducting or optical fibres), but this is normally not preferred.

In this context, the signal corresponds to the instruction entered so that the apparatus performs the action or the like (such as

playing/stopping/selecting/deleting a song/video/album/picture) as desired and instructed.

Naturally, the present invention is relevant for all types of assemblies of a remote controllable apparatus and a remote control. Typical remote controllable apparatus are radios, tuners, amplifiers, TV's, monitors, projectors, tape (such as VHS)/DVD/CD players/recorders, satellite boxes, hard drives, or the like. Also, other types of remote controllable apparatus, such as cars (e.g. toy cars), or the like are relevant for the present invention.

In this respect, the surface part adapted to support the remote control will be able to support the remote control so as to maintain the remote control in a desired position while supported or docked. This supporting may comprise a fixing of the remote control using e.g. a magnet or mechanical fixing means in order to prevent, make difficult or less probable removing the remote control when supported so as to e.g. make moving of the apparatus with the remote control docked possible without risking loosing or dropping the remote control.

The movable element at least partly covers the surface part when in its first position. This may be in order to protect or hide any electrical connecting means and/or supporting means, as will be described further below. Naturally, all of the surface part need not be covered or blocked when the movable element is in its first position. Preferably, access of the remote control to the surface part from outside the apparatus is blocked by the movable surface in this position. In one embodiment, the surface part is positioned inside the apparatus (such as within an outer surface thereof), when the movable element is in its first position. Then, one or more other surfaces of the movable element may form part of the outer surface of the apparatus, when the movable element is in the first position.

In addition, the partly covering may also act to cover additional means, positioned on the apparatus, for a user to enter instructions into the apparatus, as the remote control may be used for the user to enter the same instructions. Thus, access to such means may be desired only when the remote control is supported.

Also, the movable element either does not block or cover the surface part at all or at least to a sufficiently low degree so that the remote control may be supported, when the movable element is in its second position.

Naturally, the movement of the movable element may be any desired movement, such as a translation, rotation, sliding movement, or any combination thereof. In fact, the surface part may actually be a part of the movable element, such as a surface of the movable element presented or pointing away from the apparatus in its second position and pointing toward the apparatus in its first position.

In one embodiment, the receiving means of the remote control is positioned so as to be manipulated by the user, when the remote control is supported by the surface part. Thus, the receiving means of the remote control are available to the user and preferably point away from the apparatus in order to be visible to the user. In this manner, the remote control may be used also for controlling the apparatus, or at least certain operations or modes thereof, when the remote control is supported or docked. Then, the apparatus need not have other means for a user to operate the apparatus, or may have fewer such means, as those of the remote control may also be used.

In general, the remote control and the surface part may each comprise one or more electrical conductors adapted to engage or touch when the remote control is supported by the surface part. This has multiple advantages.

In one situation, the remote control is adapted to receive second instructions over the conductors and act in accordance with the second instructions. Such instructions forwarded to the remote control may be information to be provided on e.g. a display thereof or additional or alternative software or configuration information adapting the operation of the remote control. One example is the use of a new or generic remote control which, when supported or docked, will receive configuration information which subsequently will determine or control the behavior of the remote control. In another example, menu structures and/or hierarchies may be changed or overwritten in order to adapt the operation or user friendliness of the remote control.

In another situation, the remote control is adapted to, when receiving instructions via the receiving means while being supported, transfer the instructions to the apparatus via the electrical conductors. In this manner, a high-quality connection is secured.

In another embodiment, the remote control comprises one or more power receiving elements for receiving power, and wherein the surface part comprises corresponding power supplying element(s) for supplying power to the power receiving elements, when the remote control is supported by the surface part. This power may be used for charging e.g. a battery of the remote control and/or for powering the remote control and its operation during supporting or docking.

In yet another embodiment, the apparatus comprises a proximity sensor and means for, on the basis of a signal from the proximity sensor, moving the movable element between the first and second positions. In this situation, an automatic movement of the movable element may be facilitated when the remote control approaches the apparatus or the movable element.

In addition, the proximity sensor then preferably outputs a first signal, when the remote control is in the proximity of the apparatus and a second signal, when the remote control is not in the proximity of the apparatus, and wherein the moving means are adapted to move the movable element into its first position, when receiving the second signal from the proximity sensor.

In general, when the remote control is sufficiently close to the apparatus, the movable element may be moved into its second position, and when the remote control is farther away, the movable element may be moved to its first position.

In this context, the proximity may be the existence of any minimum distance between the remote control and the apparatus, such as at 10 m or less, such as 5 m or less, preferably 2 m or less, such as 1 m or less, such as 50 cm or less, preferably 30 cm or less.

In one situation, the proximity sensor is adapted to differ between proximity of the remote control and other elements. This has the advantage that the movable element is not moved by the approaching of e.g. an empty hand.

In one embodiment, the remote control may be adapted to output a signal (such as based on IR, WIFI, UV, RF, or the like) on the basis of which the proximity sensor will operate.

In another embodiment, the apparatus comprises means, such as a camera, for detecting the remote control, or the apparatus outputs a signal which is either detected by the remote control, whereby the remote control outputs another signal indicating to the apparatus that the remote control is close enough to sense the signal output, or the remote control may e.g. scatter or reflect the signal in a manner detectable by the apparatus.

In a preferred embodiment, the remote control comprises a magnet, and the proximity sensor comprises a magnetic sensor. This magnet may be a separately provided magnet and/or a magnet of e.g. a loudspeaker provided in the remote control for providing audio feedback or information to the user.

Preferably, the moving means are adapted to compare the signal from the proximity sensor to a predetermined value and operate the moving means when a result of the comparison exceeds a predetermined amount, the apparatus further comprising means for re-determining the predetermined value. Then, changes in the environment may be taken into account and will not bring about a movement of the movable element. In one situation, changes of a position or direction of the apparatus or sensor in relation to the earth's magnetic field or other magnetic elements, such as speakers or CRT's, may be taken into account. In another situation, the proximity of other elements during this movement normally are not desired to bring about a movement of the movable element.

In fact, it may be preferred that the apparatus further comprises means for sensing a movement of the apparatus, the re-determining means being adapted to re-determine the predetermined value on the basis of a sensed movement.

Thus, any sensed signals may be ignored during the movement of the apparatus in order to not bring about a movement of the movable element, until the movement has stopped, where after a re-calibration is performed. Then, any proximity of the remote control will again be determined and have the desired effect.

In another aspect, the invention relates to a method of operating an assembly of an apparatus and a remote control, the method comprising the steps of:
a user entering an instruction into the remote control which outputs a signal correlated to instruction received,
the apparatus receiving the signal from the remote control and acting accordingly,
moving the remote control into close proximity of the apparatus,
the apparatus detecting the proximity of the remote control and moving a movable element movable between from a first to a second position so as to uncover a surface part of the apparatus, and
finally supporting the remote control on the surface part.

In one embodiment, the remote control and the surface part each comprises one or more electrical conductors adapted to engage or touch when the remote control is supported by the surface part, the method comprising the step of the remote control receiving second instructions over the conductors and acting in accordance with the second instructions. As mentioned above, these instructions may relate to information to be provided by the remote control, such as on a display thereof, or to information adapted to change or define a configuration or operation of the remote control.

In another embodiment, the remote control and the surface part each comprises one or more electrical conductors adapted to engage or touch when the remote control is supported by the surface part, the method comprising the step of, when the remote control is supported by the surface part, the remote control receiving instructions via the receiving means and transferring the instructions or corresponding information to the apparatus via the electrical conductors. As described, in this manner, the remote control may be used as a “local” control, whereby the apparatus need not have additional (or may simply have less) controls for it to be operated, as those of the remote control may be used.

In a further embodiment, the method may further comprise the step of providing power to the remote control, while the remote control is supported by the surface part.

In a particular embodiment, the proximity sensing step is adapted to differ between proximity of the remote control and other elements. As mentioned above, this may be based on the use of electromagnetic radiation or magnetic fields.

Also, the method preferably further comprises the step of the apparatus not sensing proximity of the remote control and moving the movable element from the second position to the first position.

In a preferred embodiment, the remote control comprises a magnet, and wherein the proximity sensing step comprises sensing proximity of one or more magnets.

Also, the proximity sensing step may comprise comparing a signal from a proximity sensor to a predetermined value and operating the moving means when a result of the comparison exceeds a predetermined amount, the method further comprising re-determining the predetermined value. This may be in order to take into account changes in the environment or surroundings of the apparatus.

In a particular embodiment, the method further comprises the step of re-determining the predetermined value on the basis of a sensed movement of the apparatus.

In the following, a preferred embodiment will be described with reference to the drawing, wherein:

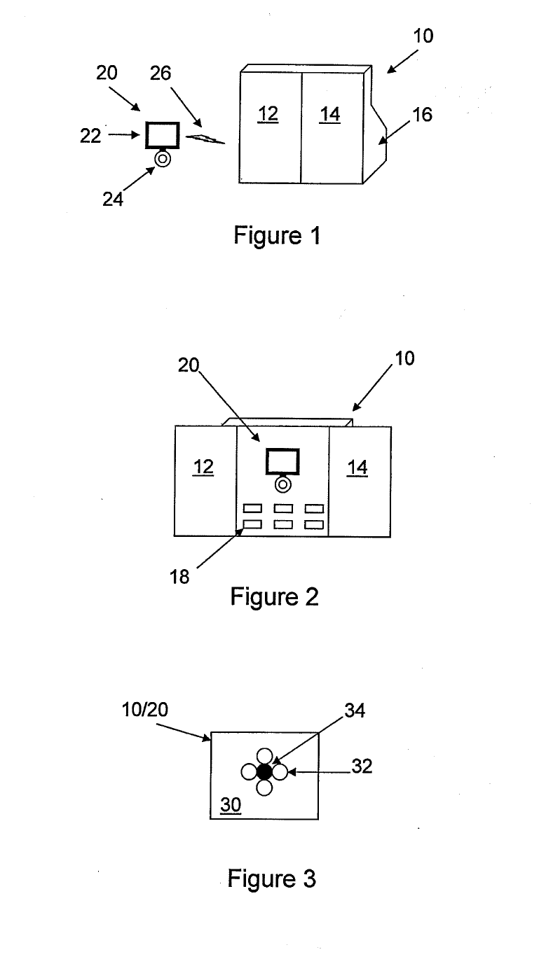

FIG. 1 illustrates an apparatus remote controlled by a remote control,

FIG. 2 illustrates the apparatus opened and supporting the remote control on a surface part thereof,

FIG. 3 illustrates the supporting surface part and the corresponding part of the remote control,

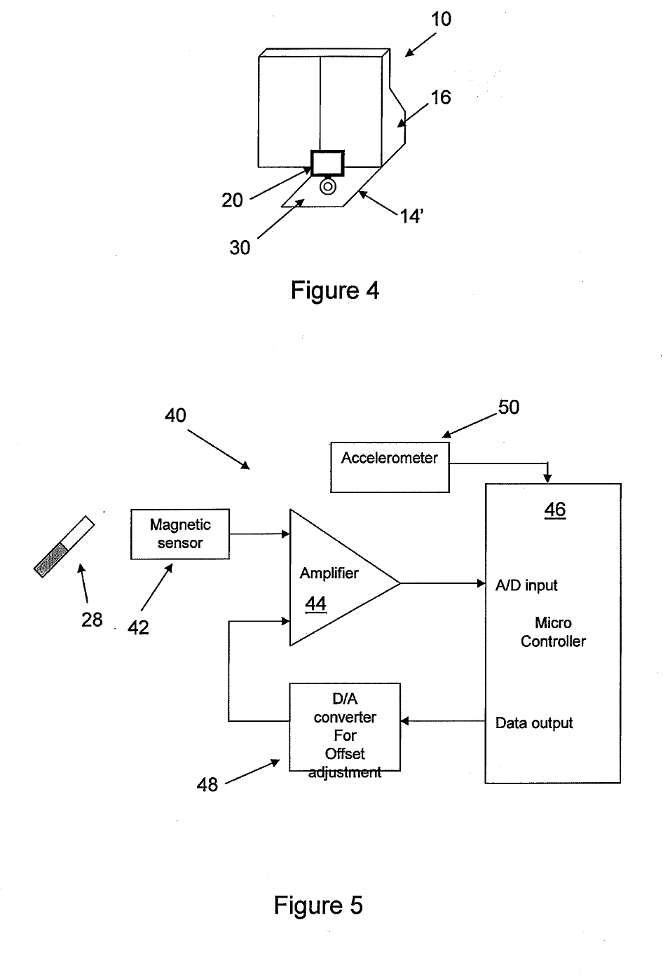

FIG. 4 illustrates an alternative to the embodiment of FIG. 2,

FIG. 5 illustrates the overall parts of the electronics of the apparatus.

FIGS. 1 and 2 illustrate an apparatus 10 having two sliding doors 12 and 14 in two different modes in which, in FIG. 1, the doors 12/14 are closed, and, in FIG. 2, the doors 12/14 are opened.

The remote control 20 has a display 22 and one or more buttons 24 for the user to control the apparatus 10 via wireless signals 26 output from the remote control 20 as a result of the pushing of one or more of the buttons 24.

The apparatus 10 is adapted to receive the signals 26 and operate in accordance therewith using electronics, receivers/detectors (cf. below) positioned in a part 16 of the apparatus. This is normal remote controlling using e.g. IR or RF signals.

In FIG. 2, however, the sliding doors 12/14 are opened, which reveals or makes available a surface part 30 (see FIG. 3) which is adapted to support the remote control 20 in order to be able to use this remote control 20 also as a “local control”, where the user may manipulate or operate the apparatus 10 by operating the remote control 20 when “docked” or supported by the surface part.

It is seen that the apparatus 10, when the doors 12/14 are closed, need not have or show any buttons, touch pads, or the like, for a user to manipulate, so that all manipulation or operation of the apparatus 10 in this state is performed using the remote control 20.

In the mode of FIG. 2, the apparatus 10 may have additional buttons 18 in order for the user to manipulate or operate at least some functions of the apparatus without manipulating the remote control 20.

While the remote control 20 is supported by the apparatus 10, electrical signals and/or power may flow between the remote control 20 and the apparatus 10.

In FIG. 3, a supporting surface 30 is illustrated having four electrically conducting surface parts 32 and a centrally positioned guiding element 34, which may be a stub or pyramid. The remote control 20 has corresponding elements 32/34 adapted to engage those of the surface 30 for this surface to support the remote control 20 and bring about electrical contacting between the remote control 20 and the apparatus 10.

This electrical contact may be used for charging a battery of the remote control 20 and/or power operation of the remote control 20 while “docked”.

In addition, any signals to be transmitted from the remote control 20 to the apparatus 10 may be forwarded via the elements 32/34 when the remote control 20 is docked. A user may operate a button 24, whereby a signal may be transmitted to the apparatus 10 via the electrical conductors 32, when the remote control 20 is “docked”. Also, signals or information to be provided to the user via the display 22 or any other information providing means, such as a loudspeaker providing audio feedback or information to the user, may be transmitted to the remote control 20 via the conductors 32. When the remote control 20 is not “docked”, this information may be transmitted to the remote control 20 by the remote link 26 being bi-directional.

In addition, and especially when the remote control 20 is “docked”, the remote control 20 may have additional or replacement software uploaded, and in fact the full operation thereof may be altered. In one situation, menu structures and/or hierarchies of the remote control may be amended or updated so as to have the remote control behave in a different manner.

In the extreme case, the remote control 20 may initially be a generic control not specifically adapted to the present apparatus 10 or any other apparatus connected thereto (TV/Video/DVD/speakers/WWW, Etc), which may be detected by the apparatus 10 which then uploads the correct functionality into the remote control 20.

In order to open the doors 12/14, the apparatus 10 comprises a sensor 42 (cf. below) which is able to sense proximity of a magnet or magnetic material 28 of the remote control 20, such as in a loudspeaker thereof also used for providing the user with audio feedback or information (cf. below).

Thus, proximity of the remote control 20 may be used to open the doors 12/14 in order to facilitate supporting the remote control 20 by the apparatus 10.

In general, when the remote control 20 is not close to the apparatus 10, the doors 12/14/14′ may be closed in order to e.g. protect the means 32/34.

FIG. 4 illustrates an alternative embodiment to that of FIG. 2, where a surface part 14′ of the apparatus is adapted to rotate from an upright position to a vertical position in order to reveal a surface part 30 adapted to engage and support the remote control 20. In the closed position, the surface part 30 points toward the apparatus 10 and, in fact, is hidden inside the apparatus in order to change the looks of the apparatus and to protect the supporting surface 30 and the means 32/34, if present.

An additional alternative may be one in which the surface part 30 is an upper surface of an element translated out of and into the apparatus 10 (such as in the same manner as a drawer). In this situation, even though this sliding element is smaller than the housing, it moves relatively to the housing which subsequently forms the function of the element covering the surface part 30.

The actual circuit 40 is illustrated in FIG. 5 in which a magnetic sensor 42 senses the magnet 28 and feeds a signal into an amplifier 44 again feeding a signal to a microcontroller 46 which then operates motors or other actuators opening or closing the doors 12/14.

The microprocessor 46 may also handle the communication/charging via the conductors 32 and may keep the doors 12/14 open while connection takes place. Naturally, the microprocessor may also handle other operations of the apparatus, such as the receiving and acting upon of signals 26 from the remote control and handling all AV digital sources, related destination means (such as storage means (hard drives, storage cards, or the like)) for photo/pictures/video/audio or the like.

However, as a magnetic sensor 42 will be sensitive to all magnetic fields, the apparatus 10 will be sensitive to movements (changes in the direction of the earth's magnetic field and presence of external speakers, TV's, CRT's or the like).

Thus, an accelerometer 50 is provided for sensing movements of the apparatus 10 and to trigger a re-calibration of the magnetic sensor 42 via an offset adjustment 48 fed into the amplifier 44 for taking into account the new offset.

In this respect, the magnetic sensor 42 may be a compass sensor with a high sensitivity and a high dynamic range.

The present remote control contains a small loudspeaker with a permanent magnet. This gives a sensing distance at about 30 cm. In order to increase the sensing distance, an extra magnet is placed in the remote control.

It is understood that the sensing distance or the sensitivity of the sensor (the definition of proximity) may be adapted by adapting the sensor/amplification/offset or the strength of the magnet(s) of the remote control to fit any desired application.

Naturally, also other types of proximity sensors may be used, such as sensors detecting the strength of a signal output from the remote control 20. This may be the wireless signal 26 or an IR/RF or other signal output of the control 20, which signal may be detected by the apparatus 10.

Naturally, alternatively, the apparatus 10 may output the signal which is then automatically detected by the remote control 20 and, if the distance is sufficiently low, the remote control 20 may output a signal to the apparatus 10 in order to have the doors 12/14 opened.

1-21. (canceled)

22. An assembly of an apparatus and a remote control,
the remote control comprising means for receiving instructions from a user and means for outputting a signal correlated to instructions received,
the apparatus comprising means for receiving a signal from the remote control and acting accordingly,
the apparatus further comprising
a surface part adapted to support the remote control,
a movable element movable between a first and a second position,
where the surface part is at least partly covered by the movable element, when the movable element is in the first position, and is not covered to any substantial degree, when the movable element is in the second position, wherein the apparatus comprises a proximity sensor and means for, on the basis of a signal from the proximity sensor, moving the movable element between the first and second positions, the proximity sensor being adapted to differ between proximity of the remote control and other elements.

23. An assembly according to claim 22, wherein the receiving means of the remote control is positioned so as to be manipulated by the user, when the remote control is supported by the surface part.

24. An assembly according to claim 22, wherein the remote control and the surface part each comprises one or more electrical conductors adapted to engage or touch when the remote control is supported by the surface part, the remote control being adapted to receive second instructions over the conductors and act in accordance with the second instructions.

25. An assembly according to claim 22, wherein the remote control and the surface part each comprises one or more electrical conductors adapted to engage or touch when the remote control is supported by the surface part, the remote control being adapted to, when receiving instructions via the receiving means, transfer the instructions to the apparatus via the electrical conductors when the remote control is supported by the surface part.

26. An assembly according to claim 22, wherein the remote control comprises one or more power receiving elements for receiving power, and wherein the surface part comprises corresponding power supplying element(s) for supplying power to the power receiving elements, when the remote control is supported by the surface part.

27. An assembly according to claim 22, wherein the remote control comprises a magnet, and wherein the proximity sensor comprises a magnetic sensor.

28. An assembly according to claim 22, wherein the moving means are adapted to compare the signal from the proximity sensor to a predetermined value and operate the moving means when a result of the comparison exceeds a predetermined amount, the apparatus further comprising means for re-determining the predetermined value.

29. An assembly according to claim 22, the apparatus further comprising means for sensing a movement of the apparatus, the re-determining means being adapted to re-determine the predetermined value on the basis of a sensed movement.

30. An assembly according to claim 22, wherein the proximity sensor outputs a first signal, when the remote control is in the proximity of the apparatus and a second signal, when the remote control is not in the proximity of the apparatus, and wherein the moving means are adapted to move the movable element into its first position, when receiving the second signal from the proximity sensor.

31. A method of operating an assembly of an apparatus and a remote control, the method comprising the steps of:
a user entering an instruction into the remote control which outputs a signal correlated to instruction received,
the apparatus receiving the signal from the remote control and acting accordingly,
moving the remote control into close proximity of the apparatus,
the apparatus detecting the proximity of the remote control and moving a movable element movable from a first to a second position so as to unblock a surface part of the apparatus, and
finally supporting the remote control on the surface part, the method further comprising the step of providing power to the remote control, while the remote control is supported by the surface part, wherein the proximity sensing step is adapted to differ between proximity of the remote control and other elements.

32. A method according to claim 31, wherein remote control and the surface part each comprises one or more electrical conductors adapted to engage or touch when the remote control is supported by the surface part, the method comprising the step of the remote control receiving second instructions over the conductors and acting in accordance with the second instructions.

33. A method according to claim 31, wherein remote control and the surface part each comprises one or more electrical conductors adapted to engage or touch when the remote control is supported by the surface part, the method further comprising the step of the remote control receiving second instructions over the conductors and acting in accordance with the second instructions.

34. A method according to claim 31, wherein the remote control and the surface part each comprises one or more electrical conductors adapted to engage or touch when the remote control is supported by the surface part, the method comprising the step of, when the remote control is supported by the surface part, the remote control receiving instructions via the receiving means and transferring corresponding information to the apparatus via the electrical conductors.

35. A method according to claim 31, wherein the remote control comprises a magnet, and wherein the proximity sensing step comprises sensing proximity of one or more magnets.

36. A method according to claim 31, wherein the proximity sensing step comprises comparing a signal from a proximity sensor to a predetermined value and operating the moving means when a result of the comparison exceeds a predetermined amount, the method further comprising re-determining the predetermined value.

37. A method according to claim 31, the method further comprising the step of re-determining means the predetermined value on the basis of a sensed movement of the apparatus.

38. A method according to claim 31, further comprising the step of the apparatus not sensing proximity of the remote control and moving the movable element from the second position to the first position.
